(19) United States
(12) Patent Application Publication
(10) Pub. No.: US 2011/0100016 A1
(43) Pub. Date: May 5, 2011

(54) APPARATUS AND METHODS FOR FUEL NOZZLE FREQUENCY ADJUSTMENT

(76) Inventors: David CIHLAR, Greenville, SC (US); Christopher Paul KEENER, Woodruff, SC (US)

(21) Appl. No.: 12/858,750

(22) Filed: Aug. 18, 2010

Related U.S. Application Data
(63) Continuation-in-part of application No. 12/610,576, filed on Nov. 2, 2009.

(51) Int. Cl. F02C 9/00; F02C 7/00

(52) U.S. Cl. 60/772; 60/752

(57) ABSTRACT

A combustion liner cap assembly includes a cylindrical sleeve with a cantilevered fuel nozzle mounted therewithin; and a plurality of support rods. Each support rod has a first end supported by the cylindrical sleeve and a second end configured to contact the cantilevered fuel nozzle. Each support rod is adjustable in effective length to provide an adjustable compression force against the cantilevered fuel nozzle. A method for adjusting a resonant frequency of a cantilevered fuel nozzle mounted in a cylindrical sleeve is provided. A plurality of support rods extend between the cylindrical sleeve and the cantilevered fuel nozzle. An associated gas turbine has at least some combustion and rotor tones of interest. The method includes adjusting an effective length of the support rods to adjust compressive forces exerted against the cantilevered fuel nozzle to increase a resonant frequency of the fuel nozzle to be greater than the combustion and rotor tones of interest.

### CROSS REFERENCE TO RELATED APPLICATION

This application is a continuation-in-part and claims the benefit of U.S. application Ser. No. 12/610,576, filed Nov. 2, 2009, the entire content of which is hereby incorporated by reference.

The present invention relates to apparatus and methods for fuel nozzle frequency adjustment.

### BACKGROUND

Excessive dynamic pressures (or dynamics) within Dry Low NOₓ(DLN) combustion systems must be avoided in order to assure acceptable system durability and reliability. As DLN combustion systems become more aggressive with regard to emissions and gas turbine cycles, the combustors tend to become less robust against these combustor dynamic pressure fluctuations (dynamics), and system failures caused by excessive dynamics are possible. Continuous monitoring of combustor dynamics may be performed to provide an instantaneous warning of excessive dynamics.

To monitor the combustor dynamics, the frequency tones of one of the acoustic modes occurring inside the combustion chamber are detected, for example by dynamic pressure sensors inside the combustion chamber or by accelerometers externally mounted on the combustor casing. The acoustic mode is a standing wave generated at one or more natural, or resonance, frequencies of a combustor and travels in a direction transverse to an axis of the combustion liner. The frequency of the acoustic mode is dependent upon combustor dimensions and the speed of sound inside the combustion chamber, the latter in turn being dependent upon the gas inside the combustion chamber. The speed of sound of the gas may be determined from the temperature and properties of the gas.

The natural frequency, or frequencies, of the fuel nozzles is a frequent issue in combustion systems. Adjustment of the natural frequency or frequencies above all combustion and rotor tones of interest that may occur during operation of the nozzles is desired to prevent damage to the nozzles that may occur if the combustor and/or rotor tone frequency is substantially equal to the natural frequency of the nozzle. However, due to the limited available space in this region, previous designs have been unable to sufficiently dampen the hardware.

### BRIEF DESCRIPTION

According to an exemplary embodiment, a combustion liner cap assembly comprises a cylindrical sleeve with a cantilevered fuel nozzle mounted therewithin; and a plurality of support rods, each support rod having a first end supported by the cylindrical sleeve and a second end configured to contact the cantilevered fuel nozzle, each support rod being adjustable in effective length to provide an adjustable compression force against the cantilevered fuel nozzle.

According to another exemplary embodiment, a combustion liner cap assembly comprises a cylindrical sleeve with a cantilevered fuel nozzle mounted therewithin; and means for providing an adjustable compression force against the cantilevered fuel nozzle.

According to yet another exemplary embodiment a method for adjusting a resonant frequency of a fuel nozzle disposed in a gas turbine combustion liner cap assembly is provided. The combustion liner cap assembly comprises a plurality of support rods extending between a cylindrical sleeve and a cantilevered fuel nozzle mounted within the sleeve. An associated gas turbine has at least some combustion and rotor tones of interest. The method comprises adjusting an effective length of the support rods to adjust compressive forces exerted against the cantilevered fuel nozzle thereby increasing a resonant frequency of the fuel nozzle to be greater than the combustion and rotor tones of interest.

### BRIEF DESCRIPTION OF THE DRAWINGS

FIG. 1 schematically depicts a fuel nozzle support according to an embodiment of the invention;

FIG. 2 schematically illustrates a combustion liner cap assembly according to an embodiment of the invention;

FIG. 3 schematically depicts a portion of the combustion liner cap assembly of FIG. 2 including a support rod;

FIG. 4 schematically depicts a portion of the fuel nozzle support of FIG. 1 including a support rod;

FIG. 5 schematically depicts a portion of the combustion liner cap assembly of FIG. 2 including a support rod;

FIG. 6 schematically depicts a portion of the combustion liner cap assembly of FIG. 2 including a support rod and sleeve; and

FIG. 7 schematically depicts a sleeve of the combustion liner cap assembly according to a sample embodiment.

### DETAILED DESCRIPTION OF EXEMPLARY EMBODIMENTS

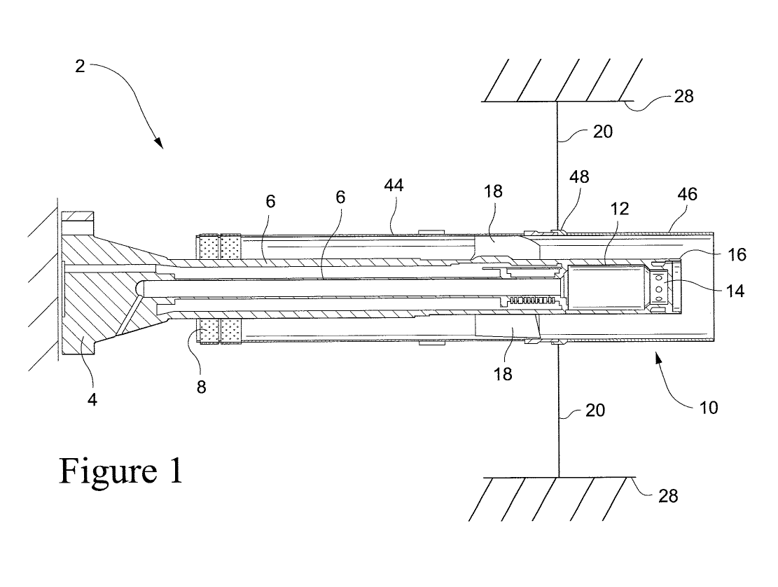

Referring to FIG. 1, a combustor comprises a center fuel nozzle 2. The center fuel nozzle 2 comprises concentric tube assemblies 6 that are supported at one end by a flange assembly 4. The center fuel nozzle 2 further comprises an inlet flow conditioner 8, for example a sheet metal screen. A shroud 10 is provided around the concentric tube assemblies 6. As shown in FIG. 1, the center fuel nozzle 2 is supported in a cantilever manner by the flange assembly 4.

The concentric tube assemblies 6 comprise a hub 12 having diffusion metering holes 14 at a fuel nozzle aft tip 16. A swirling vane or vanes 18 (i.e. a swozzle) may be provided in the shroud 10 around the concentric tube assemblies 6. As shown in FIG. 1, support rods 20 may contact the shroud 10 of the center fuel nozzle 2 at a point downstream from the swozzle 18, for example at a joint 48 between a first shroud section 44 that extends generally over the concentric tube assemblies 6 and the swizzle 18 and a second shroud section 46 that extends generally over the hub 12 and the fuel nozzle aft tip 16.

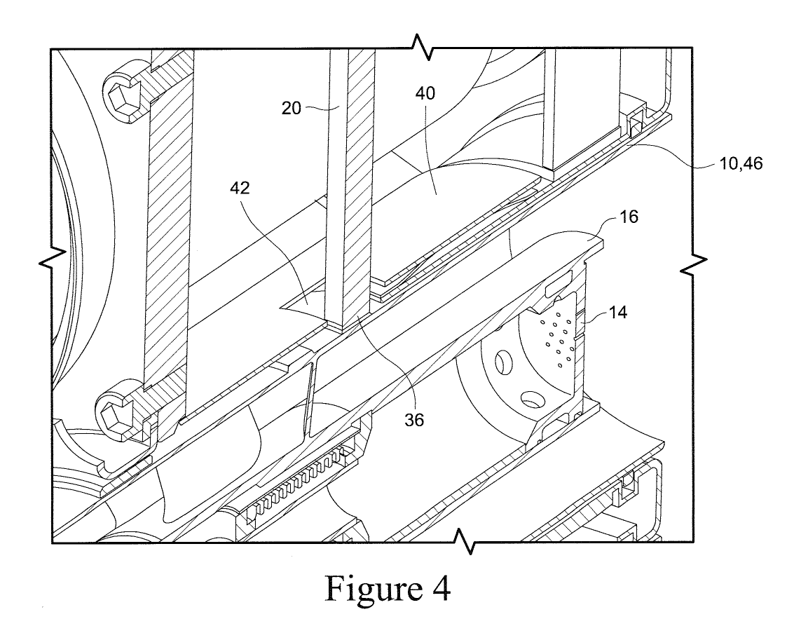

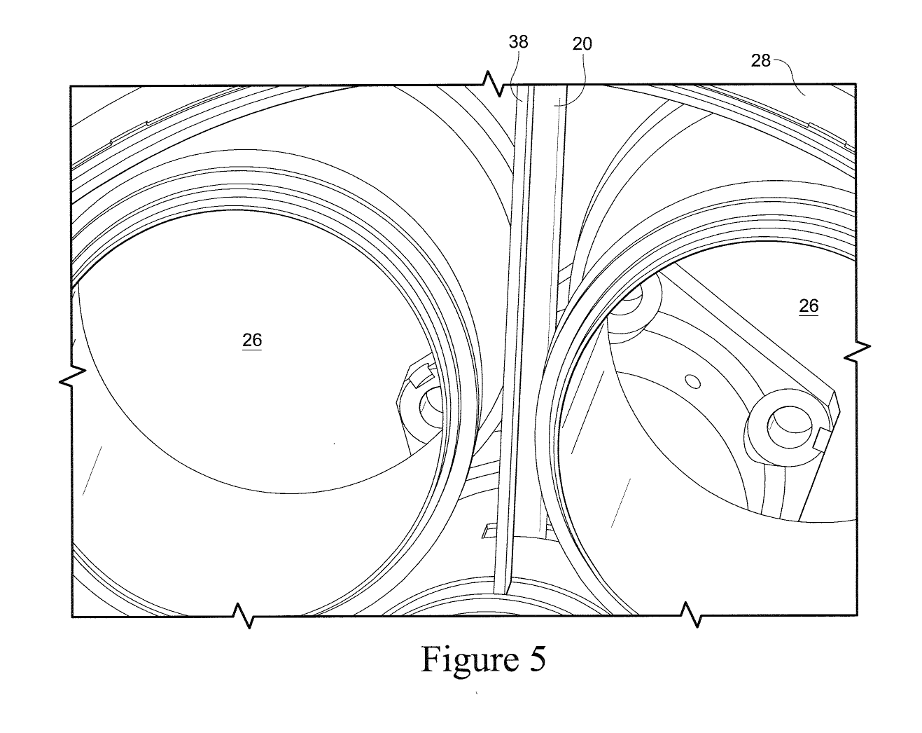

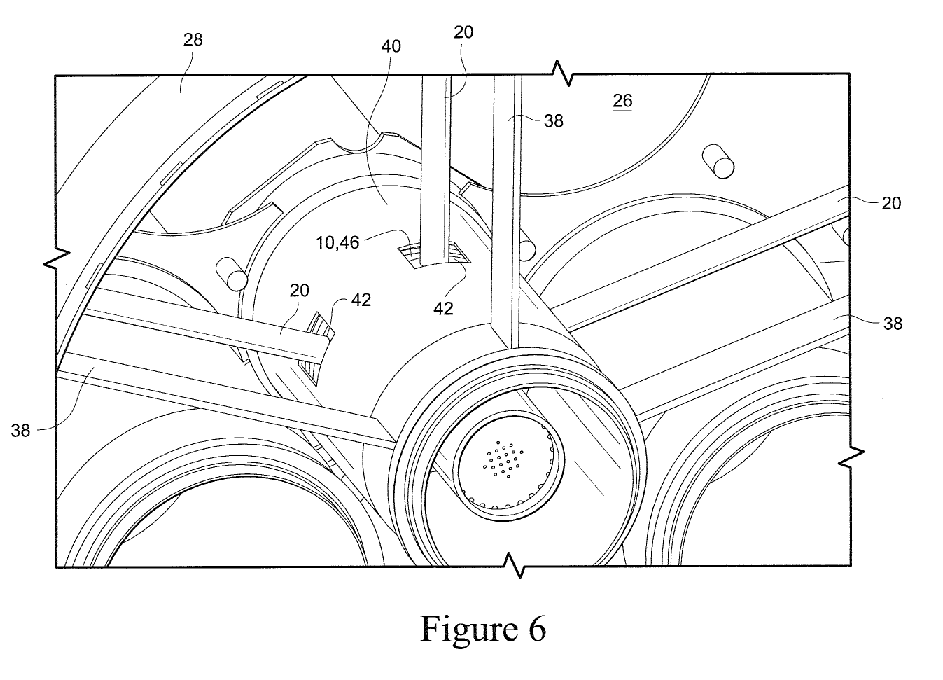

The concentric tube assemblies 6 of the center fuel nozzle 2 are supported in a shroud 10 by a plurality of support rods 20 that are provided between a cylindrical outer sleeve 28 and the outer surface of the shroud 10. Referring to FIG. 6, the support rods 20 contact the outer surface of the shroud 10 of the center fuel nozzle 2. Although the support rods 20 are shown in, for example, FIGS. 4-6 as having a generally rectangular cross section, it should be appreciated that the support rods 20 may have any cross section.

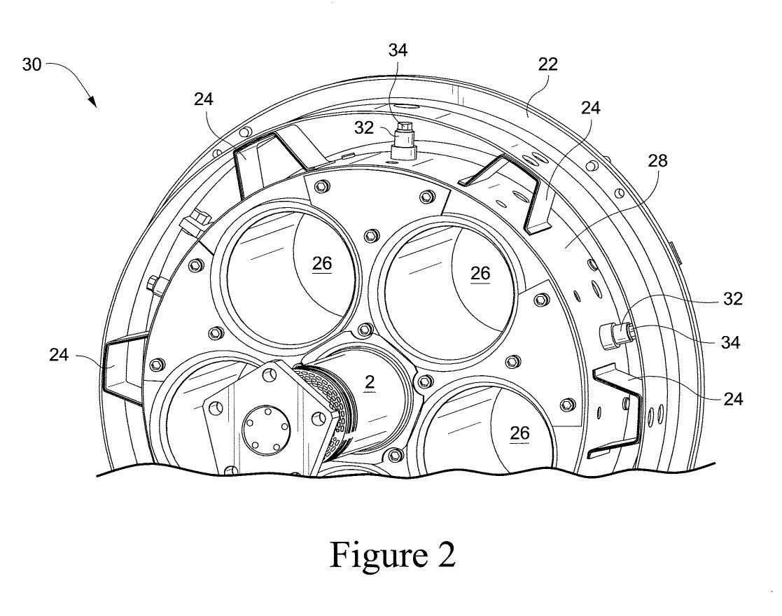

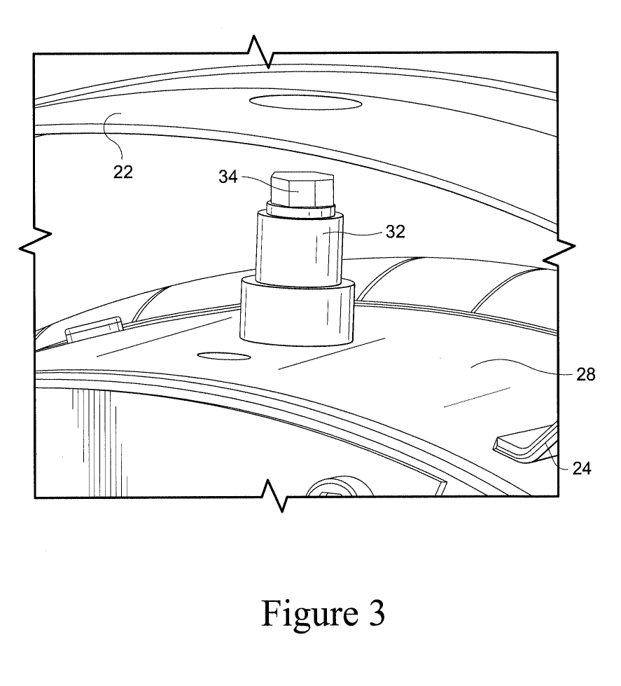

Referring to FIGS. 2 and 3, a combustion liner cap assembly 30 of the combustor comprises a mounting flange assembly 22 that concentrically surrounds the cylindrical outer sleeve 28. A plurality of struts 24 support the mounting flange assembly 22 around the cylindrical outer sleeve 28. The cylindrical outer sleeve 28 surrounds a plurality of outer fuel nozzle openings 26 which are concentrically spaced around the center fuel nozzle 2.

The cylindrical outer sleeve 28 comprises a plurality of threaded bosses 32. Each threaded boss 32 receives a first end 34 of a respective support rod 20. The first ends 34 of the support rods 20 are threaded to threadably engage with the threaded flanges 32. The first end 34 of each support rod 20 also includes a shaped end, e.g. hexagonal or octagonal, that may be engaged by a wrench or other tool to adjust the position of the support rod 20 with respect to the threaded boss 32.

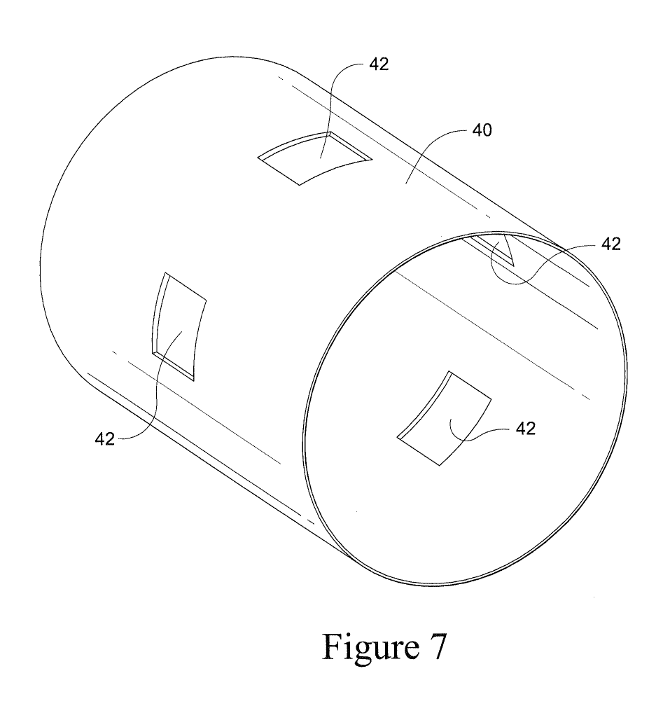

Referring to FIGS. 4-7, the support rods 20 include second ends 36 that contact the shroud 10 of the center fuel nozzle 2. The second ends 36 are in contact with, but, in this exemplary embodiment, not connected or fastened to, the shroud 10 of the center fuel nozzle. As shown in FIGS. 4 and 6, the combustor further comprises support plates 38 that support the cylindrical outer sleeve 28. A sleeve 40 is provided around the shroud 10 and includes a plurality of support rod apertures 42 through which the second ends 36 of the support rods 20 extend to contact the shroud 10. The second ends 36 of the support rods 20 that contact the shroud 10 of the center fuel nozzle 2 can be fitted with multiple designs depending on the operating conditions; bare metal, wire mesh, wear coating, etc.

In order to provide added stiffness to the cantilever mounting of the center fuel nozzle 2, the support rods 20 are added to the cap assembly 30 and are compressed against the shroud 10 of the center fuel nozzle 2 by adjusting the threaded engagement of the first ends 34 of the support rods with the threaded bosses 32 of the combustion liner cap assembly 30. The first ends 34 are adjusted in the threaded bosses 32 to compress the support rods 20 between the shroud 10 and the threaded bosses 32 on the cylindrical outer sleeve 28 of the combustion liner cap assembly 30. Each support rod 20 may be compressed an equal amount, or each support rod may be compressed a different amount, by adjusting the threaded engagement of the first end 34 of each support rod with its respective threaded boss 32.

Sensors are provided in the combustor and in the turbine to monitor the combustion dynamics of the combustor and the operation of the turbine. The sensors may be, for example, combustion dynamic pressure sensors, flame sensors, and/or accelerometers. Signals from the sensors may be processed to identify tones, or frequencies, of interest. For example, the signals may be processed as disclosed in U.S. Pat. No. 7,278,266, although it should be appreciated that other signal processing may be used.

The support rods 20 act as a stiff spring in contact with the shroud 10 of the center fuel nozzle 2. The compression of the support rods 20 provides sufficient damping to increase the natural frequency of the center fuel nozzle 2 beyond combustion or rotor tones of interest that may occur during operation of the combustor. The compression of the support rods 20 also reduces the amplitude response, i.e. vibration, of the center fuel nozzle 2 through the increased dampening.

The support rods 20 may be compressed to increase the natural frequency of the center fuel nozzle beyond combustion and/or rotor tones that the combustor may experience under specified operating conditions. The amount of compression of the support rods, or of each support rod, may vary depending on operating conditions. Different operating conditions may require different amounts of compression of the support rods to increase the natural frequency of the center fuel nozzle beyond combustion and rotor tones that may be generated at particular operating conditions.

The number of support rods that are provided may depend on the amount of space available in the combustor, e.g. the space available between the outer sleeve of the combustion liner cap assembly and the shroud. In general, the more support rods that are provided the more dampening will occur.

The support rods 20 provide sufficient stiffness to increase the natural frequency of the center fuel nozzle beyond combustion and rotor tones of interest, and reduce the amplitude response through the increased dampening. The support rods 20 may increase the natural frequency of the center fuel nozzle by a factor between two and three. This increase in stiffness allows for a more robust and durable fuel design capable of exceeding current hardware performance.

The support rods 20 can be retrofitted against existing combustion systems with few, if any, design changes required on the center fuel nozzle. Modifications may include providing the sleeve 40 with apertures, or forming apertures in an existing sleeve. The combustion liner cap assembly may be modified by adding threaded bosses to an existing cylindrical outer sleeve, or providing a new cylindrical outer sleeve with threaded bosses. This allows for salvage of fielded hardware. Use of existing hardware allows customers to continue operation until part life is reached.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A combustion liner cap assembly, comprising
a cylindrical sleeve with a cantilevered fuel nozzle mounted therewithin; and
a plurality of support rods, each support rod having a first end supported by the cylindrical sleeve and a second end configured to contact the cantilevered fuel nozzle, each support rod being adjustable in effective length to provide an adjustable compression force against the cantilevered fuel nozzle.

2. A combustion liner cap assembly according to claim 1, wherein the fuel nozzle comprises a swirling vane, and the support rods are configured to contact the cantilevered fuel nozzle at an area substantially adjacent the swirling vane.

3. A combustion liner cap assembly according to claim 1, wherein the cantilevered fuel nozzle is centered within the cylindrical sleeve.

4. A combustion liner cap assembly according to claim 1, wherein the support rods are circumferentially spaced around the cantilevered fuel nozzle.

5. A combustion liner cap assembly according to claim 1, wherein the second ends of the support rods comprise at least one of bare metal, a wire mesh, or a wear coating.

6. A combustor for a gas turbine, comprising:
a combustion liner cap assembly according to claim 1;
a plurality of outer fuel nozzles provided around the cantilevered fuel nozzle; and
a mounting flange assembly that surrounds and supports the cylindrical sleeve.

7. A combustion liner cap assembly, comprising
a cylindrical sleeve with a cantilevered fuel nozzle mounted therewithin; and
means for providing an adjustable compression force against the cantilevered fuel nozzle.

8. A combustion liner cap assembly according to claim 7, wherein the fuel nozzle comprises a swirling vane, and the adjustable compression force providing means are configured to contact the cantilevered fuel nozzle at an area substantially adjacent the swirling vane.

9. A combustion liner cap assembly according to claim 7, wherein the cantilevered fuel nozzle is centered within the cylindrical sleeve.

10. A combustion liner cap assembly according to claim 7, wherein the adjustable compression force providing means are circumferentially around the cantilevered fuel nozzle.

11. A combustion liner cap assembly according to claim 7, wherein the adjustable compression force providing means contact the cantilevered fuel nozzle via at least one of bare metal, a wire mesh, or a wear coating.

12. A combustor for a gas turbine, comprising:
a combustion liner cap assembly according to claim 7;
a plurality of outer fuel nozzles provided around the cantilevered fuel nozzle; and
a mounting flange assembly that surrounds and supports the cylindrical sleeve.

13. A method for adjusting a resonant frequency of a fuel nozzle disposed in a gas turbine combustion liner cap assembly, the combustion liner cap assembly comprising a plurality of support rods extending between a cylindrical sleeve and a cantilevered fuel nozzle mounted within the sleeve, an associated gas turbine having at least some combustion and rotor tones of interest, the method comprising:
adjusting an effective length of the support rods to adjust compressive forces exerted against the cantilevered fuel nozzle thereby increasing a resonant frequency of the fuel nozzle to be greater than the combustion and rotor tones of interest.

14. A method according to claim 13, wherein the resonant frequency is adjusted to be at least twice the highest frequency of the combustion and rotor tones of interest.

15. A method according to claim 13, wherein the fuel nozzle comprises a swirling vane, and the support rods are configured to contact the cantilevered fuel nozzle at an area substantially adjacent the swirling vane.

16. A method according to claim 13, wherein the cantilevered fuel nozzle is centered within the cylindrical sleeve.

17. A method according to claim 13, wherein the support rods are circumferentially spaced around the cantilevered fuel nozzle.

18. A method according to claim 13, wherein the second ends of the support rods comprise at least one of bare metal, a wire mesh, or a wear coating.
